(19) United States
(12) Patent Application Publication
(10) Pub. No.: US 2009/0190360 A1
(43) Pub. Date: Jul. 30, 2009

(54) LIGHT-EMITTING DECORATING DEVICE

(76) Inventor: Chi-Shih Lai, Panchiao (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/419,243

(22) Filed: Apr. 6, 2009

Related U.S. Application Data
(63) Continuation-in-part of application No. 11/979,795, filed on Nov. 8, 2007.

(51) Int. Cl. F21V 3/00; F21S 8/08

(52) U.S. Cl. 362/311.13; 362/410

(57) ABSTRACT

A light-emitting decorating device includes a framework, a light-transmitting cover and at least one light source. The framework is a hollow construction and comprises a plurality of supporting brackets and a plurality of decorating brackets provided between the supporting brackets. The light-transmitting cover is provided inside the framework, thereby the framework and the light-transmitting cover together constituting the profile of the light-emitting decorating device. The light source is provided in the interior of the light-transmitting cover. Via the above arrangement, a light-emitting decorating device can be achieved, thereby generating a better visual effect and adding a novel and shining effect to the whole profile.

### CROSS-REFERENCE TO RELATED APPLICATIONS

This application is a Continuation-in-Part of application Ser. No. 11/979,795, filed on 8 Nov. 2007, and entitled LIGHT-EMITTING DECORATING DEVICE.

### BACKGROUND OF THE INVENTION

1. Field of the Invention

The present invention is related to a light-emitting decorating device, and more particular to a light-emitting decorating device that has a three-dimensional profile and can emit light variably via an associated light source to generate a better visual effect.

2. Description of Related Art

On important festivals and celebrations, people will decorate their houses to symbolize the festival, thereby generating a festival atmosphere. Further, the decorations can be made of light-transmitting materials, and light sources are disposed in the interior of the decorations. With the light sources emitting the light, a light-emitting decorating device can be achieved, thereby generating a better decorating effect. In the above-mentioned light-emitting decorating device, the light sources are simply disposed in the interior of the decorating device. Therefore, when the light of the light source pierces the decorating device so as to emit outwardly, the visual effect generated is limited. As a result, it is difficult to generate a better visual effect.

For example, Taiwan Patent publication No. M262373 published on Apr. 21, 2005 discloses an improved structure of a light-emitting decoration, in which light-emitting elements are provided in a base and the interior of a light-transmitting portion to emit the light, the light pierces the base and the light-transmitting portion to emit outwardly. However, the visual effect generated is still so limited that it is difficult to generate a better visual effect. U.S. Pat. No. 1,719,198 disclosed a lamp used in bedrooms and sick rooms and the lamp is provided for projecting ornamental and attractive lights. However, the lamp simply provides a single and boring visual effect.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a light-emitting decorating device that is capable of generating a better visual effect so as to add a novel and shining effect to the whole profile.

For achieving the object described above, the present invention provides a light-emitting decorating device, which includes: a hollow framework, the framework comprising a plurality of supporting brackets and a plurality of decorating brackets provided between the supporting brackets; a light-transmitting cover provided inside the framework, the framework and the light-transmitting cover together constituting the profile of the light-emitting decorating device; and at least one light source provided in the interior of the light-transmitting cover.

The present invention has advantageous effects as follows. The light source of the present invention can emit light to pierce the light-transmitting cover and the framework so as to emit outwardly. Since the light-emitting decorating device has a three-dimensional profile, the material property of the light-transmitting cover and the variable profile of the framework exhibited outside the light-transmitting cover together with the variable light of the light source can generate a better visual effect so as to add a novel and shining effect to the whole profile.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a perspective view showing the light-emitting decorating device of the present invention;

FIG. 2 is a cross-sectional view showing the light-emitting decorating device of the present invention;

FIG. 3 is a perspective view showing an operating state of the light-emitting decorating device of the present invention; and

FIG. 4 is a perspective view showing an operating state of the light-emitting decorating device in accordance with another embodiment of the present invention.

FIG. 5 is a perspective view showing the third embodiment of the light-emitting decorating device in accordance with another embodiment of the present invention.

FIG. 6 is an explored view showing the third embodiment of the light-emitting decorating device in accordance with another embodiment of the present invention.

### DETAILED DESCRIPTION OF THE PREFERRED EMBODIMENTS

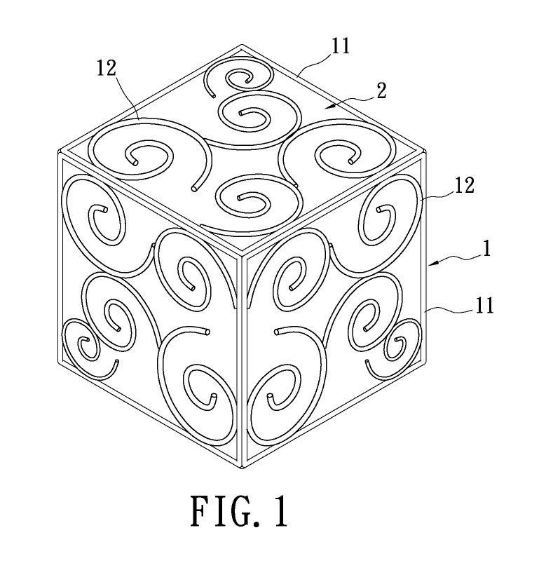

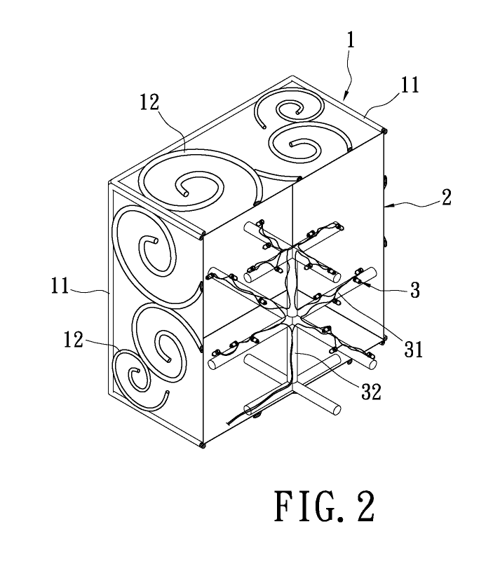

Please refer to FIGS. 1 to 3. The present invention is to provide a light-emitting decorating device, the shape of which is not limited to particular ones but can be formed into various animals, plants, cartoon figures, geometric shapes or other arbitrary shapes. For example, the light-emitting decorating device can have shapes of snowman, Santa Claus, angel, deer, cane, gift box, snowflake, Christmas tree, sleigh, or pumpkin and the light-emitting decorating device is used in X'mas or Halloween. In the present embodiment, the light-emitting decorating device is a cubic body which includes a framework 1, a light-transmitting cover 2 and at least one light source 3. The shape and construction of the framework 1 are not limited to particular forms and can be substantially formed into a profile corresponding to that of the light-emitting decorating device. In the present embodiment, the light-emitting decorating device is a cubic body, so that the framework 1 has a corresponding hollow cubic construction. The framework 1 is made of metallic or plastic materials. The framework 1 comprises a plurality of supporting brackets 11 that are connected to form a cubic construction. A plurality of decorating brackets 12 is provided between the supporting brackets 11. The decorating brackets 12 may have a shape of various patterns or characters. In the present embodiment, the decorating bracket 12 is a volute line. Furthermore, the framework 1 has a concave 113 thereon and the power supply line 31 can extend from the interior space of the framework 1 to the exterior space of the light-emitting decorating device. In the embodiment shown in FIG. 1, the concave 113 is formed on the supporting brackets 11.

The light-transmitting cover 2 is made of a plastic piece, cloth or paper that has a light-transmitting property. The light-transmitting cover 2 can be made of three-dimensional cloth, for example the light-transmitting cover 2 has 3D shape made by material of PVC. Furthermore, the light-transmitting cover 2 has property of partial light reflection and partial light transmission. The color of the light-transmitting cover 2 can be varied according to practical demands, and patterns or characters can be printed on the light-transmitting cover 2. The light-transmitting cover 2 is fixedly provided in the inside or outside of the framework 1. In the present embodiment, the light-transmitting cover 2 is provided in the inside of the framework 1, so that the framework 1 and the light-transmitting cover 2 together constitute the profile of the light-emitting decorating device. The framework 1 is exposed to the outside (inside) of the light-transmitting cover 2, thereby displaying a three-dimensional aesthetic feeling of the framework 1. Portions of the light-transmitting cover 2 is fixed on the supporting brackets 11 and a plurality of points of the inner portion of the light-transmitting cover 2 is attached on the decorating brackets 12 by gluing so that the light-transmitting cover 2 can form an unsmooth surface in the inside of the framework 1. In other words, the framework 1 (including supporting brackets 11 and decorating brackets 12) performs the rigid structure of the light-emitting decorating device and the light-transmitting cover 2 is a soft material connected to the framework 1 so as to form an unsmooth and various surface of the light-emitting decorating device.

The light source 3 can be various light-emitting elements such as light-emitting diodes (LED), bulbs, lamp tubes or Christmas lamps. The number and locations of the light sources 3 are not limited and can be varied according to practical demands. The shining state and the colors of the light sources 3 can be also suitably controlled to generate a better decorating effect. The light source 3 is electrically connected to a power supply line 31 which penetrates through the concave 113 of the supporting brackets 11 to connect electrically to the power socket or power supply. When the power supply line 31 supplies the power necessary for the light source 3, the light source 3 can emit the light immediately. In the present embodiment, there is a plurality of light sources 3. These light sources 3 are suitably supported and fixed within the framework 1 via supports 32 and the light sources 3 are fixed on the supports 32 by ties. Alternatively, the light source 3 is movably disposed on the supports 32 for adjusting the position of the light source 3. The light-transmitting cover 2 is used for diffusing the light of the light source 3 and the decorating brackets 12 is used for sheltering the light so as to form the various lighting effects. Via the above construction, the light-emitting decorating device of the present invention can be achieved. In other words, the light of the light source 3 can project a predetermined image to user's eyes through the unsmooth surface of the light-transmitting cover 2 and the decorating brackets 12 and the visual effects of the light-emitting decorating device are various.

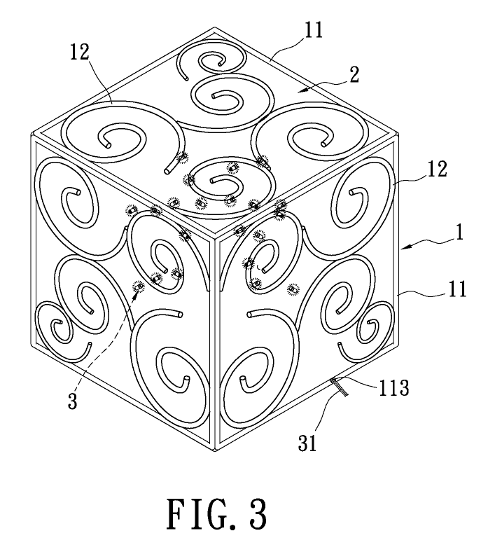

When the power supply line 31 supplies the power necessary for the light source 3, the light source 3 can emit the light immediately. The emitted light pierces the light-transmitting cover 2 and the framework 1 to emit outwardly (FIG. 3). Since the light-emitting decorating device of the present invention has a three-dimensional profile, the material property of the light-transmitting cover 2 and the variable profile of the framework 1 exhibited outside (or inside) the light-transmitting cover 2 together with the variable light of the light source 3 can generate a better visual effect so as to add a novel and shining effect to the whole profile.

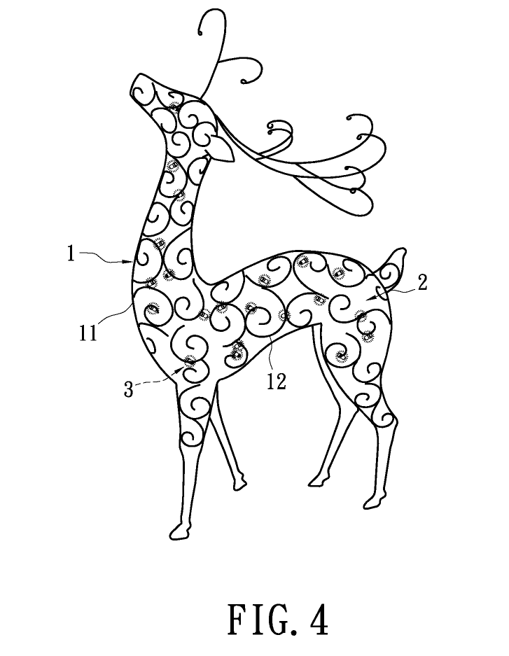

Please refer to FIG. 4. In the present embodiment, the light-emitting decorating device has a deer shape. Therefore, the framework 1 is a construction having a corresponding deer shape. The framework 1 comprises a plurality of supporting brackets 11. The supporting brackets 11 are connected to form a desired profile. The decorating brackets 12 are formed into volute lines and are disposed between the supporting brackets 11. The light-transmitting cover 2 is provided in the inside or outside of the framework 1, thereby the framework 1 and the light-transmitting cover 2 together constituting the profile of the light-emitting decorating device. The light source 3 is provided in the inside of the light-transmitting cover 2. Since the usage and function of the present embodiment are substantially identical to those of the previous embodiment, the description thereof is omitted for simplicity.

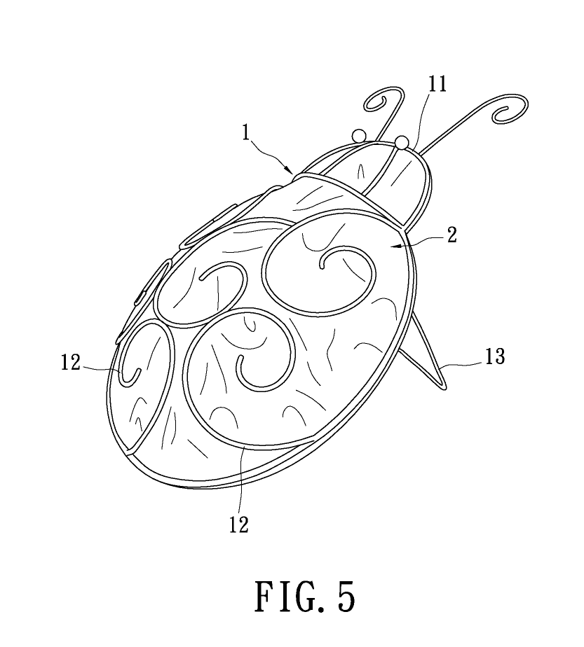

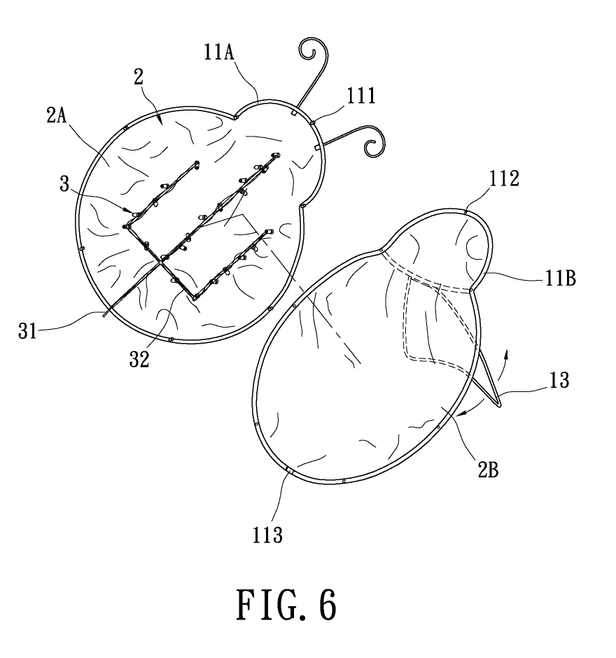

Please refer to FIGS. 5 and 6, the third embodiment is shown. The framework 1 constructs as an insect shape. In the present invention, the framework 1 comprises a first supporting bracket 11A and a second supporting bracket 11B. The first supporting bracket 11A and the second supporting bracket 11B both have decorating brackets 12 which extends from the first supporting bracket 11A and the second supporting bracket 11B. Alternatively, the decorating brackets 12 can only formed on the first supporting bracket 11A (i.e., the upper supporting bracket). Moreover, the first supporting bracket 11A has a plurality of first fixing member 111 thereon and the second supporting bracket 11B has a plurality of second fixing member 112 thereon. By locking the first fixing member 111 and the second fixing member 112, the first supporting bracket 11A can be assembled with the second supporting bracket 11B. In the embodiment, the first fixing member 111 is a locking pillar and the second fixing member 112 is a locking hole, but not restricted thereby.

On the other hand, the light-transmitting cover 2 includes a first light-transmitting cover 2A and a second light-transmitting cover 2B. The first light-transmitting cover 2A and the second light-transmitting cover 2B are respectively attached on the first supporting bracket 11A and the second supporting bracket 11B. The first light-transmitting cover 2A and the second light-transmitting cover 2B are formed into unsmooth surfaces to diffuse the light of the light source 3.

Furthermore, the framework 1 further comprises a supporting rod 13 pivotably disposed on the second supporting bracket 11B. One end of the supporting rod 13 is pivotedly connected to the second supporting bracket 11B and the supporting rod 13 can rotate relative to the framework 1 (as shown in FIG. 5). When the light-emitting decorating device is placed on the ground, the supporting rod 13 can be used for adjusting the standing state of the light-emitting decorating device so that the decorating effects are various. On the other hand, the supporting rod 13 can be used for supporting the light-emitting decorating device with improved stability.

In contrast with the traditional decorating device, the light-emitting decorating device of the present invention can project light with attractive visual effects due to the unsmooth surface of light-transmitting cover 2. The unsmooth surface is provided for diffusing the lights of the light source 3 so that human can feel the different images in the different view angles. Furthermore, the supporting rod 13 is used for adjusting the standing states of the device so as to improving the visual effects of the light-emitting decorating device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light-emitting decorating device, comprising:
a hollow framework, the framework comprising a plurality of supporting brackets and a plurality of decorating brackets provided between the supporting brackets;
a light-transmitting cover provided in the inside of the framework, the framework and the light-transmitting cover together constituting a profile of the light-emitting decorating device, the edge of the light-transmitting cover being fixed on the supporting brackets, and a plurality of points of the inner portion of the light-transmitting cover being attached on the decorating brackets so that the light-transmitting cover forming an unsmooth surface in the inside of the framework; and
at least one light source provided inside the light-transmitting cover, the light of the light source projecting a predetermined image to user's eyes through the unsmooth surface and the decorating brackets.

2. The light-emitting decorating device according to claim 1, wherein the decorating brackets have a shape of predetermined patterns or characters.

3. The light-emitting decorating device according to claim 1, wherein the light-transmitting cover is a plastic piece, cloth or a paper piece.

4. The light-emitting decorating device according to claim 1, wherein the light source is a light-emitting diode, bulb, lamp tube or Christmas lamp.

5. The light-emitting decorating device according to claim 1, wherein the light source is electrically connected with a power supply line to supply the electricity for the light source.

6. The light-emitting decorating device according to claim 1, further comprising at least one support inside of the framework, wherein the light source is disposed on the support.

7. The light-emitting decorating device according to claim 6, wherein the light source is movably disposed on the support.

8. The light-emitting decorating device according to claim 6, wherein the light source is fixed on the support.

9. The light-emitting decorating device according to claim 1, wherein the framework comprises a first supporting bracket and a second supporting bracket, the decorating brackets extends from the first supporting bracket and the second supporting bracket.

10. The light-emitting decorating device according to claim 9, wherein the first supporting bracket has a plurality of first fixing member thereon and the second supporting bracket has a plurality of second fixing member thereon.

11. The light-emitting decorating device according to claim 9, wherein the light-transmitting cover comprises a first light-transmitting cover and a second light-transmitting cover, the first light-transmitting cover is attached on the first supporting bracket and the second light-transmitting cover is attached on the second supporting bracket.

12. The light-emitting decorating device according to claim 9, wherein the framework further comprises a supporting rod pivotably disposed on the second supporting bracket.

13. The light-emitting decorating device according to claim 9, wherein the second supporting bracket further has a concave thereon.

14. The light-emitting decorating device according to claim 1, wherein the supporting bracket further has a concave thereon.

15. The light-emitting decorating device according to claim 1, wherein the is framework made of metallic material or plastic material.

16. The light-emitting decorating device according to claim 1, wherein the light-transmitting cover has property of partial light reflection and partial light transmission.
